(19) United States
(12) Patent Application Publication
(10) Pub. No.: US 2004/0203947 A1
(43) Pub. Date: Oct. 14, 2004

(54) Apparatus and method for storing and accessing wireless device e-mail attachments

(75) Inventor: Bryan J. Moles, Dallas, TX (US)

Correspondence Address: Docket Clerk, P.O. Drawer 800889, Dallas, TX, 75380, US

(73) Assignee: SAMSUNG ELECTRONICS CO., LTD., Suwon-city (KR)

(21) Appl. No.: 10/238,359

(22) Filed: Sep. 10, 2002

(51) Int. Cl. H04M 11/10; H04Q 7/20

(52) U.S. Cl. 455/466; 455/412.1

(57) ABSTRACT

An apparatus and method is disclosed for storing and accessing wireless device e-mail attachments. Some wireless devices (such as basic cell phones) have insufficient memory and processing power to read e-mail attachments. Prior art e-mail systems delete e-mail attachments if a wireless device is not capable of receiving attachments to an e-mail message. The present invention prevents the loss of e-mail attachments by storing the e-mail attachments in an e-mail attachment database for later retrieval by the recipient of the e-mail message. The present invention notifies the recipient of the location of the e-mail attachments with an e-mail attachment notification message that contains a network address and password.

### TECHNICAL FIELD OF THE INVENTION

The present invention is directed, in general, to wireless networks and, more specifically, to a system for delivering an electronic mail (e-mail) message to a wireless mobile station using a short messaging service (SMS) message and storing attachments to the e-mail at a separate location so that the e-mail attachments may be later retrieved by the operator of the wireless mobile station.

### BACKGROUND OF THE INVENTION

The radio frequency (RF) spectrum is a limited commodity. Only a small portion of the spectrum can be assigned to each communications industry. The assigned spectrum, therefore, must be used efficiently in order to allow as many frequency users as possible to have access to the spectrum. Multiple access modulation techniques are some of the most efficient techniques for utilizing the RF spectrum. Examples of such modulation techniques include time division multiple access (TDMA), frequency division multiple access (FDMA), and code division multiple access (CDMA).

In order to attract and retain subscribers, wireless service providers frequently introduce end-user services that are desirable to consumers. These end-user services may include e-mail and web browsing provided via the wireless network. In mobile stations that have relatively large memory capacity and processing power, such as a laptop computer, implementing end-user services is a straightforward procedure.

However, conventional e-mail service requires that the mobile station have both Transmission Control Protocol/Internet Protocol (TCP/IP) capability and Simple Mail Transfer Protocol (SMTP) capability. Unfortunately, both TCP/IP and SMTP require a large amount of memory and high processing capability. As a practical matter, this means that many conventional cell phones, personal digital assistants (PDAs) and pagers are unable to support a conventional e-mail program, such as Microsoft Outlook or Eudora, because of the small memory and limited processing power of these devices.

These types of devices usually have sufficient memory and processing power to receive short messaging service (SMS) messages. When a sender wants to send an SMS message to a cell phone, the sender sends an e-mail to the cell phone using an artificial e-mail address such as<phone number>@<domainname.com>. The service provider network intercepts this message and copies the contents of the body of the e-mail message into the body of an SMS message. Any attachments to the e-mail are removed and ignored. The service network provider then delivers the SMS message to the cell phone.

The primary disadvantage of this method is that the e-mail attachments are not delivered. Many e-mail attachments are written using a word processor (e.g., Microsoft Word or Corel Word Perfect) and are too large to be read on a cell phone. The presently available SMS systems, however, generally delete all e-mail attachments, regardless of the size of the e-mail attachment.

There is therefore a need in the art for an improved system and method for delivering e-mail messages to a wireless mobile station so that e-mails attachments to the e-mail messages are not deleted and lost.

### SUMMARY OF THE INVENTION

To address the above-discussed deficiencies of the prior art, it is a primary object of the present invention to provide, for use in a wireless network, a system and method for delivering e-mail messages to a wireless mobile station so that e-mail attachments to the e-mail messages are not deleted and lost.

The apparatus of the present invention comprises a short messaging service (SMS) controller coupled to the wireless network. The SMS controller is capable of receiving at least one e-mail attachment and storing the e-mail attachment for later retrieval by an operator of a wireless mobile station. The apparatus further comprises an e-mail attachment database coupled to the SMS controller. The e-mail attachment database comprises a plurality of storage sites for storing e-mail attachments.

When the SMS controller receives an e-mail message from the wireless network, the SMS controller (1) converts the e-mail text into an SMS text, (2) stores the e-mail attachment in the e-mail attachment database, (3) generates an e-mail user name and e-mail password, (4) and generates an attachment notification message (containing the user name, the password, and the network address of the stored e-mail information). The SMS controller then sends the SMS text and the attachment notification message to the wireless mobile station.

The operator of the wireless mobile station reads the SMS text and the attachment notification message. Then the operator of mobile station is then able to subsequently retrieve the e-mail attachment from the e-mail attachment database using an attachment retrieving device (such as a personal computer).

It is an object of the present invention to provide an improved system and method for storing e-mail attachments in an e-mail attachment database so that an operator of a wireless mobile station can access and retrieve the e-mail attachments at his or her convenience.

It is a further object of the present invention to provide an improved system and method for providing information to an operator of a wireless mobile station concerning the location of e-mail attachments and how the operator can access and retrieve the e-mail attachments.

It is also an object of the present invention to provide an improved system and method for providing an attachment notification message that contains identification information, a user name, a password, and a network address assigned to an e-mail attachment of an e-mail message.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior uses, as well as to future uses, of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates exemplary wireless network according to an advantageous embodiment of the present invention;

FIG. 2 illustrates the exemplary wireless network shown in FIG. 1 coupled to a short messaging service (SMS) controller and attachment database that are capable of receiving and re-formatting an e-mail having an e-mail attachment, delivering the e-mail to a destination mobile station as an SMS message, and storing the e-mail attachment for later retrieval in accordance with to the principles of the present invention;

FIG. 3 illustrates in greater detail the short messaging service (SMS) controller and the attachment database shown in FIG. 2 according to an advantageous embodiment of the present invention; and

FIG. 4 is a flow diagram illustrating the operation of the short messaging service (SMS) controller and the attachment database according to an advantageous embodiment of the present invention.

### DETAILED DESCRIPTION OF THE INVENTION

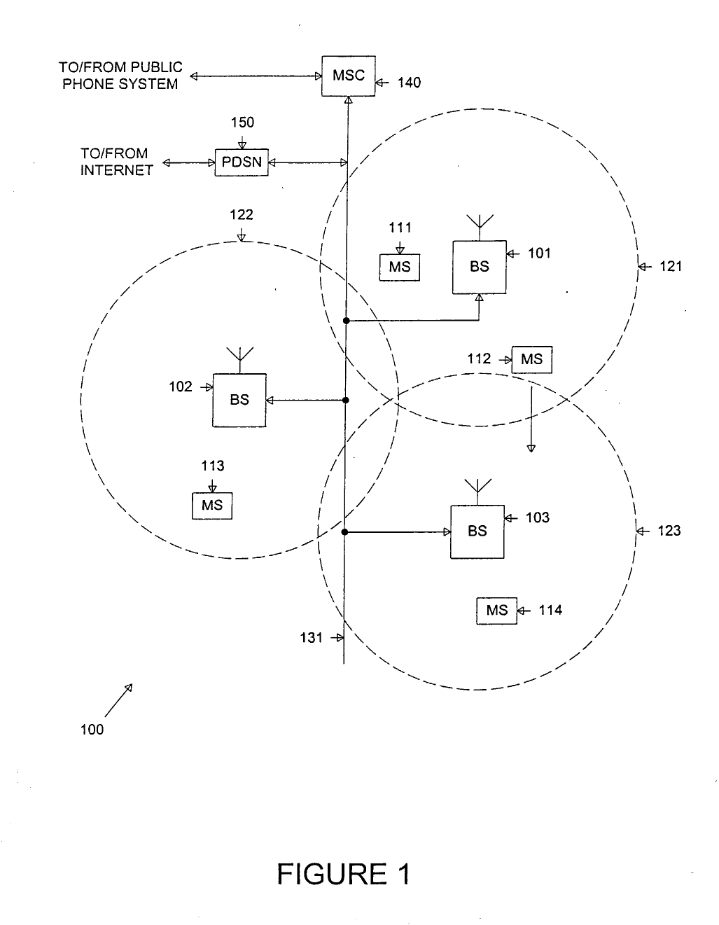

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 illustrates exemplary wireless network 100 according to one embodiment of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over, for example, code division multiple access (CDMA) channels. Mobile stations 111-114 may be any relatively small wireless devices, including conventional cellular radiotelephones, Personal Communications System (PCS) handset devices, personal digital assistants, or the like.

Dotted lines show the approximate boundaries of the cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, cell sites 121-123 are comprised of a plurality of sectors (not shown), each sector being illuminated by a directional antenna coupled to the base station. The embodiment of FIG. 1 illustrates the base station in the center of the cell. Alternate embodiments position the directional antennas in corners of the sectors. The system of the present invention is not limited to any one cell site configuration.

In one embodiment of the present invention, BS 101, BS 102, and BS 103 comprise a base station controller (BSC) and one or more base transceiver subsystems (BTS). Base station controllers and base transceiver subsystems are well known to those skilled in the art. A base station controller is a device that manages wireless communications resources, including the base transceiver stations, for specified cells within a wireless communications network. A base transceiver subsystem comprises the RF transceivers, antennas, and other electrical equipment located in each cell site. This equipment may include air conditioning units, heating units, electrical supplies, telephone line interfaces, and RF transmitters and RF receivers. For the purpose of simplicity and clarity in explaining the operation of the present invention, the base transceiver subsystem in each of cells 121, 122, and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data serving node (PDSN) 150. Line 131 also provides the connection path to transfers control signals between MSC 140 and BS 101, BS 102 and BS 103 used to establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. Those skilled in the art will recognize that the connections on line 131 may provide a transmission path for transmission of analog voice band signals, a digital path for transmission of voice signals in the pulse code modulated (PCM) format, a digital path for transmission of voice signals in an Internet Protocol (IP) format, a digital path for transmission of voice signals in an asynchronous transfer mode (ATM) format, or other suitable connection transmission protocol. Those skilled in the art will recognize that the connections on line 131 may provide a transmission path for transmission of analog or digital control signals in a suitable signaling protocol.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

As is well known, the hand-off procedure transfers control of a call from a first cell site to a second cell site. As MS 112 moves from cell 121 to cell 123, MS 112 detects the pilot signal from BS 103 and sends a Pilot Strength Measurement Message to BS 101. When the strength of the pilot transmitted by BS 103 and received and reported by MS 112 exceeds a threshold, BS 101 initiates a soft hand-off process by signaling the target BS 103 that a handoff is required as described in TIA/EIA IS-95 or TIA/EIA IS-2000.

BS 103 and MS 112 proceed to negotiate establishment of a communications link in the CDMA channel. Following establishment of the communications link between BS 103 and MS 112, MS 112 communicates with both BS 101 and BS 103 in a soft handoff mode. Those acquainted with the art will recognize that soft hand-off improves the performance on both forward (BS to MS) channel and reverse (MS to BS) channel links. When the signal from BS 101 falls below a predetermined signal strength threshold, MS 112 may then drop the link with BS 101 and only receive signals from BS 103. The call is thereby seamlessly transferred from BS 101 to BS 103.

The above-described soft hand-off assumes the mobile station is in a voice or data call. An idle hand-off is a hand-off of a mobile station, between cells sites, that is communicating in the control or paging channel.

According to the principles of the present invention, wireless network 100 is capable of receiving e-mails directed to selected ones of mobile stations 111-114.

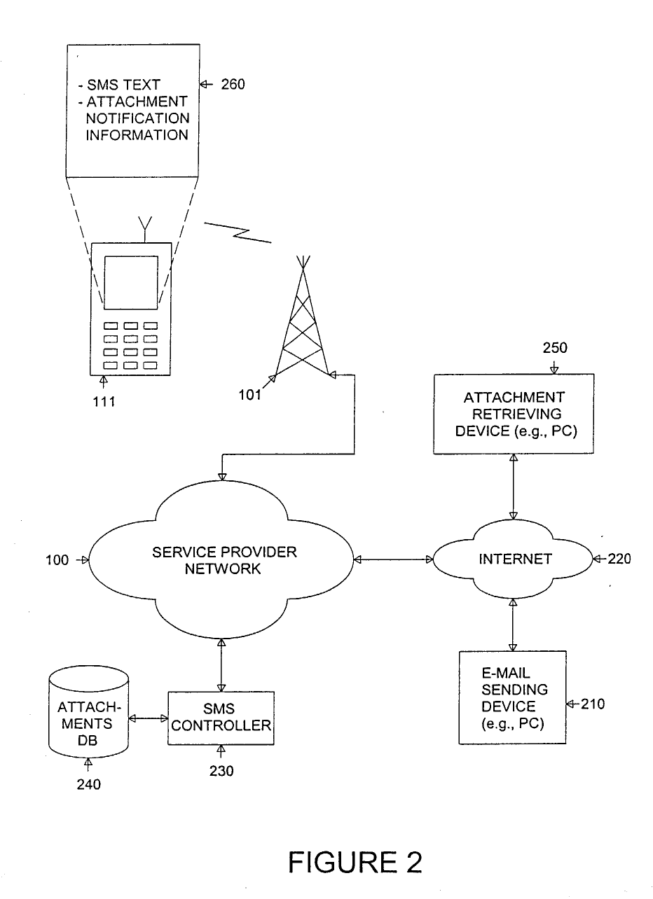

FIG. 2 illustrates how the present invention operates in conjunction with wireless network 100 to receive and re-format an e-mail having an e-mail attachment for delivery to a mobile station using a short messaging service (SMS) message. In the exemplary embodiment shown in FIG. 2, wireless network 100 comprises service provider network 100. Service provider network 100 is capable of sending an e-mail message to mobile station 111 (MS 111) through base station 101 (BS 101). Service provider network 100 is coupled to the Internet 220. It is understood that Internet 220 is merely one example of a communications network and that the present invention is not restricted to be used only with Internet 220. It is understood that the principles of the present invention may be used in conjunction with any type of communications network.

As shown in FIG. 2, exemplary e-mail sending device 210 is coupled to Internet 220. A user who desires to send an e-mail message to mobile station 111 (MS 111) sends the e-mail message from e-mail sending device 210 through Internet 220 to service provider network 100.

Service provider network 100 then sends the e-mail to short messaging service (SMS) controller 230 that is coupled to service provider network 100. SMS controller 230 comprises a communications network server or other similar type of computerized data processing system. Attachment database 240 is coupled to SMS controller 230. As will be more fully described, if SMS controller 230 determines that the e-mail has an e-mail attachment, SMS controller 230 stores the e-mail attachment (and the e-mail text) in attachment database 240. SMS controller 230 then assigns identification information (e.g., a number or string identifier) to the e-mail attachment so that the e-mail attachment may be accessed and retrieved from attachment database 240 at a later time.

SMS controller 230 then copies the text of the e-mail into the body of an SMS message. SMS controller 230 then creates an attachment notification message and adds the attachment notification message to the SMS message. The attachment notification message informs the operator of mobile station 111 that an e-mail attachment accompanied the e-mail message and that the e-mail attachment can be accessed and retrieved from attachment database 240 by using the identification information.

SMS controller then sends the SMS message to mobile station 111. The operator of mobile station 111 reads the SMS message on display screen 260 of mobile station 111. At a later time the operator of mobile station 111 may use an attachment retrieving device 250 (e.g., a personal computer 250) coupled to Internet 220 to access and retrieve the attachment from attachment database 240.

In this manner the operator of mobile station 111 has access to all e-mail attachments that are attached to his or her e-mails. Unlike prior art systems that discard e-mail attachments, the present invention preserves the e-mail attachments for later access and retrieval.

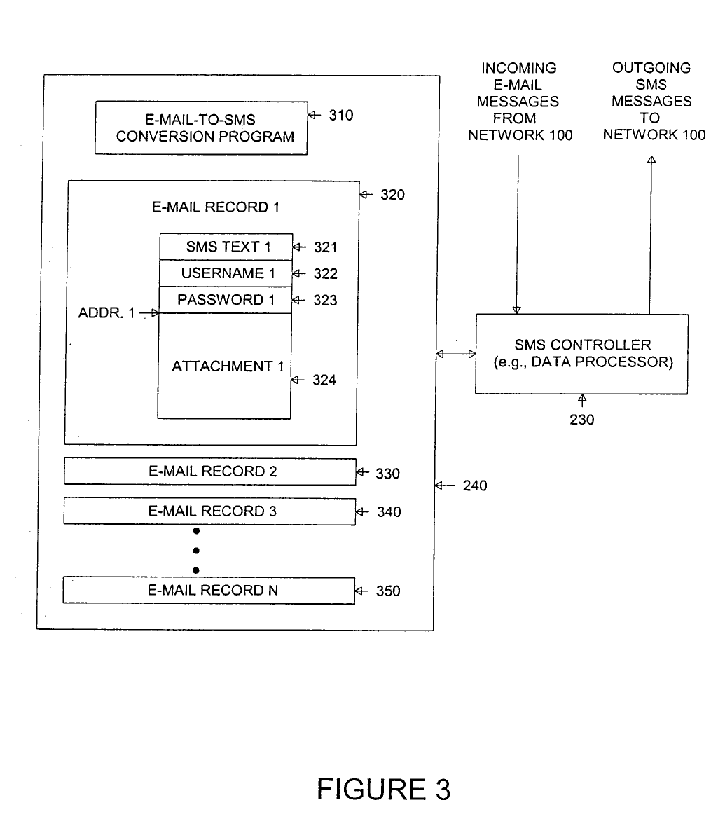

FIG. 3 illustrates short messaging service (SMS) controller 230 and attachments database 240 in greater detail according to one embodiment of the present invention. In FIG. 3, SMS controller 230 comprises a conventional data processor 230 that receives incoming e-mail messages from service provider network 100 and transmits outgoing SMS messages to service provider network 100. Attachments database 240 stores E-mail-to-SMS conversion program 310, which is executed by data processor 230. In an alternative embodiment, E-mail-to-SMS conversion program 310 may be stored within data processor 230.

Attachments database 240 also stores N e-mail records, including exemplary e-mail records 320, 330, 340 and 350. E-mail record 320 is arbitrarily labeled E-Mail Record 1, e-mail record 330 is arbitrarily labeled E-Mail Record 2, e-mail record 340 is arbitrarily labeled E-Mail Record 3, and e-mail record 350 is arbitrarily labeled E-Mail Record N.

Exemplary e-mail record 320 comprises SMS text data field 321, username data field 322, password data field 323, and attachment data field 324. SMS text data field 321 is arbitrarily labeled SMS Text 1. Username data field 322 is arbitrarily labeled Username 1. Password data field 323 is arbitrarily labeled Password 1. Attachment data field 324 is arbitrarily labeled Attachment 1. Attachment 1 has a starting address labeled Address 1 in FIG. 3. Exemplary e-mail records 330, 340 and 350 contain the same data fields for their respective e-mail messages.

Assume that SMS controller 230 receives an incoming e-mail from service provider network 100 to be delivered to mobile station 111. SMS controller 230 accesses E-mail-to-SMS conversion program 310 in attachment database 240 and converts the text of the e-mail to an SMS message. SMS controller 230 stores the SMS message text in SMS text data field 321 of E-mail record 320 (E-mail Record 1). SMS controller 230 stores the e-mail attachment in attachment data field 324 (Attachment 1) of E-mail record 320. SMS controller 230 records the address (Address 1) of attachment data field 324 (Attachment 1).

SMS controller 230 then assigns identification information (e.g., a number or string identifier) to the e-mail attachment so that the e-mail attachment may be later accessed and retrieved from e-mail record 320 of attachment database 240. In one advantageous embodiment the identification information may take the form of a user name stored in username data field 322. For security purposes, SMS controller 230 may assign a password for the user to use to access e-mail record 320. The password for e-mail record 320 is stored in password data field 323.

If the e-mail received by SMS controller 230 contains more than one e-mail attachment, then SMS controller 230 stores each additional e-mail attachment (and associated information concerning location and access) in one of the other e-mail record locations available (i.e., e-mail record 330 (E-mail Record 2) through e-mail record 350 (E-mail Record N)). In one advantageous embodiment of the present invention, the user name and the password may be the same for each e-mail attachment that is attached to one e-mail.

After SMS controller 230 has re-formatted the incoming e-mail message and e-mail attachment as described above, SMS controller 230 prepares an outgoing SMS message to be sent to mobile station 111. SMS controller 230 first places the SMS version of the e-mail text (from SMS text data field 321) into the outgoing SMS text message. SMS controller 230 then places the following information in the outgoing SMS text message: (1) User name from username data field 323, (2) Password from password data field 323, and (3) Address 1 of attachment data field 324.

SMS controller 230 also generates a message for the operator of mobile station 111 that explains that an e-mail attachment that had been attached to the e-mail has been stored for later retrieval by the operator. This explanatory message is also placed within the SMS text message. Then SMS controller 230 sends the SMS text message to mobile station 111 through service provider network 100.

The operator of mobile station 111 receives the SMS text message and the accompanying attachment notification message. The operator of mobile station 111 subsequently uses the information in the SMS text message to access and retrieve the e-mail attachment (or e-mail attachments) from attachment database 240 using attachment retrieving device 250 (e.g., a personal computer).

In some instances the operator of mobile station 111 may have an attachment retrieving device 250 that has sufficient storage and processing power to receive e-mail attachments that is already connected to service provider network 100. In those instances, the operator of mobile station 111 may make prior arrangements for SMS controller 230 to simultaneously send the SMS text message together with the e-mail (and the e-mail attachments) directly to the e-mail address of attachment retrieving device 250.

In one advantageous embodiment of the present invention, SMS controller 230 and attachment database 240 are accessible at a website of server provider network 100. In another advantageous embodiment of the present invention, SMS controller 230 and attachment database 240 are accessible at a File Transfer Protocol (FTP) site of server provider network 100.

The website or FTP site must provide an interface for the operators of the mobile stations to delete e-mail attachments from attachment database 240. Otherwise, the number of e-mail attachment files would continue to grow until attachment database 240 was full. To solve this problem the service provider sets a “maximum database usage” policy for e-mail attachments located on attachment database 240. Under a “maximum database usage” policy, if an operator of a mobile station exceeds his or her allotted disk storage on attachment database 240, then no additional e-mail attachments will be stored. The additional e-mail attachments will be lost.

Alternatively, the “maximum database usage” policy may be directed to the sender of the e-mails (and not to the recipient). In this alternative embodiment of the present invention, the e-mail attachments are stored in attachment database 240 in disk storage locations that are allocated to the sender. The recipient of the e-mails (i.e., the operator of a mobile station) would be able to receive information allowing him or her to retrieve e-mail attachments from the sender's memory locations on attachment database 240. If the sender exceeds his or her allotted disk storage on attachment database 240, then no additional e-mail attachments will be stored. The additional e-mail attachments will be lost. In this case, the website or FTP site must provide an interface for the senders of the e-mails to delete e-mail attachments from attachment database 240.

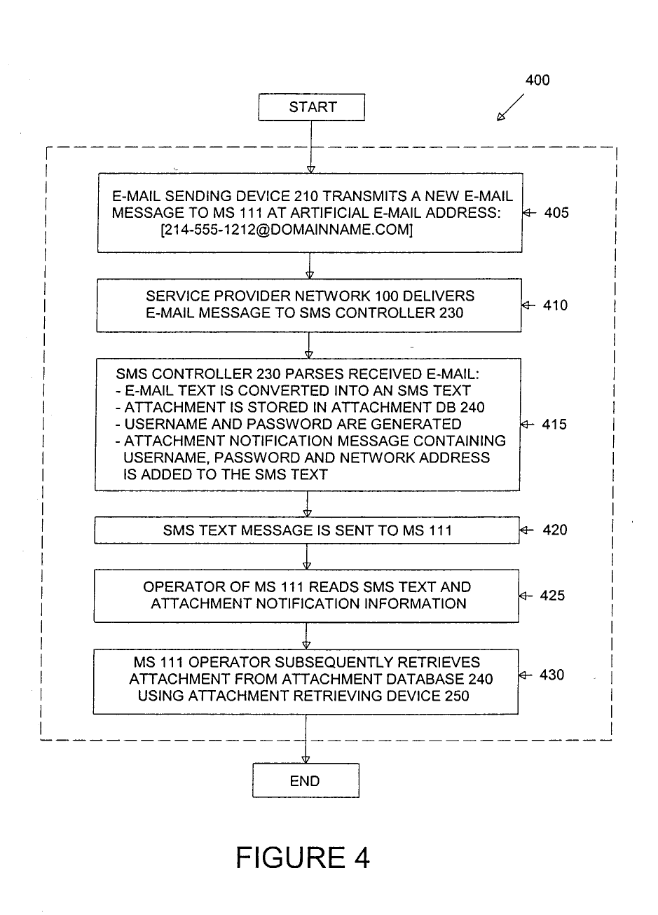

FIG. 4 is a flow diagram illustrating an exemplary method of operation of SMS controller 230 and attachment database 240 according to an advantageous embodiment of the present invention. The steps of the method are collectively referred to with reference numeral 400.

In the method shown in FIG. 4E-mail sending device 210 sends a new e-mail message to mobile station 111 at an artificial e-mail address (step 405). The artificial e-mail address comprises a telephone number and a domain name (here, domainname.com). Service provider network 100 receives the e-mail message and sends it to SMS controller 230 (step 410). SMS controller 230 receives the e-mail message and parses it as follows: (1) the e-mail text is converted into an SMS text, (2) the e-mail attachment is stored in attachment database 240, (3) an e-mail user name and e-mail password are generated, (4) an attachment notification message (comprising the user name, the password, and the network address of the stored e-mail information) is added to the SMS text (step 415).

Then SMS controller 230 sends the SMS text to mobile station 111 (step 420). The operator of mobile station 111 reads the SMS text and the attachment notification information that it contains (step 425). Then the operator of mobile station 111 subsequently retrieves the e-mail attachment from attachment database 240 using attachment retrieving device 250 (step 430).

Although the present invention has been described in detail, those skilled in the art should understand that they could make various changes, substitutions and alterations herein without departing from the spirit and scope of the invention in its broadest form.

What is claimed is:

1. For use in a wireless network capable of communicating with mobile stations located in a coverage area of the wireless network, an apparatus for delivering to a first one of said mobile stations an e-mail message having at least one e-mail attachment so that said at least one e-mail attachment of said e-mail message is not lost, said apparatus comprising:
a short messaging service (SMS) controller coupled to said wireless network, said SMS controller capable of receiving said at least one e-mail attachment and storing said at least one e-mail attachment for later retrieval by an operator of said first one of 11 said mobile stations.

2. The apparatus as set forth in claim 1 further comprising an e-mail attachment database coupled to said SMS controller, said e-mail attachment database capable of receiving said at least one e-mail attachment from said SMS controller and capable of storing said at least one e-mail attachment in an attachment data field of an e-mail record.

3. The apparatus as set forth in claim 2 wherein said e-mail attachment database comprises an e-mail-to-SMS conversion program capable of converting e-mail text to SMS text.

4. The apparatus as set forth in claim 2 wherein said e-mail attachment database is capable of receiving from said SMS controller an SMS text version of said e-mail message having said at least one e-mail attachment and storing said SMS text version of said e-mail message in an SMS text data field of an e-mail record.

5. The apparatus as set forth in claim 2 wherein said e-mail attachment database is capable of receiving from said SMS controller identification information assigned to said at least one e-mail attachment and capable of storing said identification information assigned to said at least one e-mail attachment in an e-mail record.

6. The apparatus as set forth in claim 2 wherein said e-mail attachment database is capable of receiving from said SMS controller a user name assigned to said at least one e-mail attachment and capable of storing said user name of said at least one e-mail attachment in a username data field of an e-mail record.

7. The apparatus as set forth in claim 2 wherein said e-mail attachment database is capable of receiving from said SMS controller a password assigned to said at least one e-mail attachment and capable of storing said password of said at least one e-mail attachment in a password data field of an e-mail record.

8. The apparatus as set forth in claim 2 wherein said SMS controller is capable of creating and sending to said first one of said mobile stations (1) an SMS text version of said e-mail message, and (2) an attachment notification message, said attachment notification message containing information for accessing said at least one e-mail attachment of said e-mail message.

9. The apparatus as set forth in claim 8 wherein said attachment notification message comprises one of: identification information, a user name, a password, and a network address assigned to said at least one e-mail attachment of said e-mail message.

10. A wireless network comprising:
a plurality of base stations capable of communicating with mobile stations located in a coverage area of said wireless network; and
an apparatus for delivering to a first one of said mobile stations an e-mail message having at least one e-mail attachment so that said at least one e-mail attachment of said e-mail message is not lost, said apparatus comprising:
a short messaging service (SMS) controller coupled to said wireless network, said SMS controller capable of receiving said at least one e-mail attachment and storing said at least one e-mail attachment for later retrieval by an operator of said first one of said mobile stations.

11. The wireless network as set forth in claim 10 wherein said apparatus further comprises an e-mail attachment database coupled to said SMS controller, said e-mail attachment database capable of receiving said at least one e-mail attachment from said SMS controller and capable of storing said at least one e-mail attachment in an attachment data field of an e-mail record.

12. The wireless network as set forth in claim 11 wherein said e-mail attachment database comprises an e-mail-to-SMS conversion program capable of converting e-mail text to SMS text.

13. The wireless network as set forth in claim 11 wherein said e-mail attachment database is capable of receiving from said SMS controller an SMS text version of said e-mail message having said at least one e-mail attachment and storing said SMS text version of said e-mail message in an SMS text data field of an e-mail record.

14. The wireless network as set forth in claim 11 wherein said wherein said e-mail attachment database is capable of receiving from said SMS controller identification information assigned to said at least one e-mail attachment and capable of storing said identification information assigned to said at least one e-mail attachment in an e-mail record.

15. The wireless network as set forth in claim 14 wherein said identification information assigned to said at least one e-mail attachment comprises one of: a user name, a password, and a network address.

16. The wireless network as set forth in claim 11 wherein said SMS controller is capable of creating and sending to said first one of said mobile stations (1) an SMS text version of said e-mail message, and (2) an attachment notification message, said attachment notification message containing information for accessing said at least one e-mail attachment of said e-mail message, said information comprising one of: identification information, a user name, a password, and a network address assigned to said at least one e-mail attachment of said e-mail message.

17. In a wireless network capable of communicating with mobile stations located in a coverage area of the wireless network, a method for delivering to a first one of said mobile stations an e-mail message having at least one e-mail attachment so that said at least one e-mail attachment of said e-mail message is not lost, said method comprising the steps of:
receiving said e-mail message and said at least one e-mail attachment in a short messaging service (SMS) controller coupled to said wireless network;
storing said at least one e-mail attachment in an e-mail attachment database coupled to said SMS controller;
creating an SMS text version of said e-mail message and an attachment notification message containing information for accessing said at least one e-mail attachment; and
sending said SMS text version of said e-mail message and said attachment notification message to said first one of said mobile stations.

18. The method as set forth in claim 17 further comprising the step of:
accessing said at least one e-mail attachment from said e-mail database using an attachment retrieving device coupled to said wireless network.

19. The method as set forth in claim 17 further comprising the steps of:
creating a user name for said at least one e-mail attachment;
creating a password for said at least one e-mail attachment;
sending said user name and said password to said first one of said mobile stations in said attachment notification message; and
allowing access to said at least one e-mail attachment on said e-mail attachment database only when access is attempted with said user name and with said password.

20. The method as set forth in claim 17 further comprising the steps of:
storing a plurality of e-mail attachments in said e-mail attachment database for a user;
allowing said user to delete said plurality of said e-mail attachments from said e-mail attachment database; and
ceasing to store e-mail attachments in said e-mail attachment database for a user when said plurality of e-mail attachments for said user on said e-mail attachment database exceeds the capacity of storage locations in said e-mail attachment database that are allotted to said user.
